(19) United States
(12) Patent Application Publication
(10) Pub. No.: US 2012/0118463 A1
(43) Pub. Date: May 17, 2012

(54) Pneumatic Object Provided with a Self-Sealing and Gas-Tight Layer Comprising a Thermoplastic Elastomer and Extension Oil

(76) Inventors: Pierre Lesage, Clemont-Ferrand (FR); José Merino Lopez, Riom (FR)

(21) Appl. No.: 13/132,786

(22) PCT Filed: Nov. 30, 2009
(86) PCT No.: PCT/EP2009/008501

§ 371 Date: Sep. 14, 2011

(30) Foreign Application Priority Data
Dec. 3, 2008 (FR) 0858239

(51) Int. Cl. B60C 19/00; B32B 25/08; B32B 27/00; B32B 1/06; B32B 1/08

(52) U.S. Cl. 152/502; 428/12

(57) ABSTRACT

An inflatable article provided with an elastomer layer comprising at least, as major elastomer, a thermoplastic polystirene/polyisobutylene block copolymer, such as a stirene/isobutylene/stirene (SIBS) copolymer, and at least 100 phr of an extender oil. Preferably, this copolymer comprises between 5% and 50% stirene by weight, its number-average molecular weight is between 30,000 and 500,000 g/mol and its Tg is below −20° C. The extender oil is preferably a polybutene oil such as polyisobutylene (PIB) oil. This elastomer layer is able to fulfil not only the role of a self-sealing (puncture-resistant) layer, but also that of an impermeable layer, furthermore with a reduced hysteresis compared to a conventional layer based on butyl rubber. The inflatable article can be, in particular, an inner tube or a pneumatic tire for a motor vehicle.

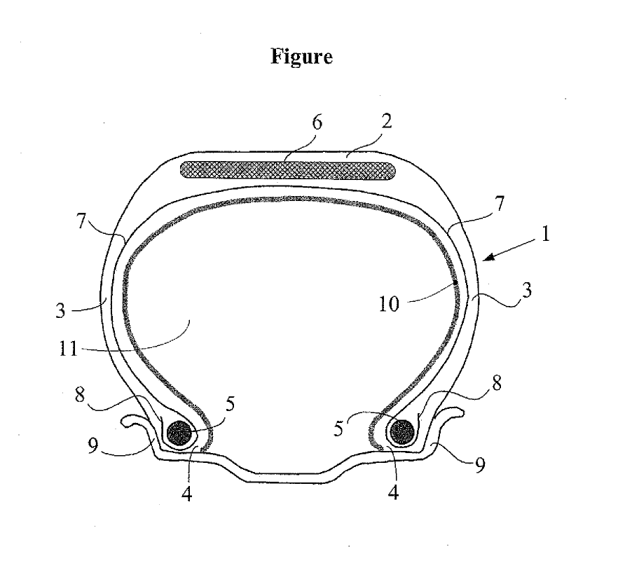

The present invention relates to “inflatable” articles, that is to say, by definition, to articles that assume their useable shape when they are inflated with air or with an equivalent inflation gas.

More particularly, the invention relates, on the one hand, to the self-sealing compositions used as puncture-resistant layers in inflatable articles, in particular in pneumatic tires, and on the other hand to gastight layers or compositions that provide the impermeability in such inflatable articles.

Self-sealing compositions that can be used as puncture-resistant layers in pneumatic tires are well known. By definition, the compositions are capable automatically, i.e. without any external intervention, of sealing a pneumatic tire in the event of it being punctured by a foreign body, such as a nail, and have been particularly difficult to develop. Indeed, self-sealing layers must satisfy many conditions of a physical and chemical nature, and be effective over a very wide operating temperature range and over the entire lifetime of the pneumatic tires. They must be capable of closing up the hole when the puncturing object remains in place and, when the latter is expelled, they must be able to fill the hole and seal the tire, especially under winter conditions. The self-sealing compositions that have been used to date in pneumatic tires are essentially based on butyl rubber (copolymer of isobutylene and isoprene).

On the other hand, it will be recalled that in a conventional pneumatic tire of the “tubeless” type (that is to say of the type without an inner tube), the radially internal face comprises an airtight layer (or more generally a layer that is impermeable to any inflation gas) which enables the pneumatic tire to be inflated and kept under pressure. Its impermeability properties enable it to guarantee a relatively low rate of pressure loss, making it possible to keep the tire inflated, in the normal operating state, for a sufficient time, normally several weeks or several months. It also has the role of protecting the carcass reinforcement from the diffusion of air coming from the internal space of the tire. This role of airtight inner layer or “inner liner” is today fulfilled by compositions that are also based on butyl rubber and are long renowned for their excellent impermeability properties.

However, one well-known drawback of compositions based on butyl rubber is that they have high hysteresis losses, furthermore over a wide temperature range, which drawback degrades the rolling resistance of pneumatic tires.

Reducing both the hysteresis of the airtight inner layers and those of the self-sealing layers in pneumatic tires, and therefore in fine the fuel consumption of motor vehicles, is a constant objective of pneumatic tire manufacturers that the current technology often comes up against.

Patent application WO 2008/080557 proposed the use, in a pneumatic tire, of a self-sealing layer that is completely devoid of butyl rubber, and that therefore already partly meets the above objective of reducing hysteresis. This self-sealing layer has the feature of comprising, as major elastomer, a thermoplastic stirene elastomer and an extender oil at a particularly high content, between 200 and 700 phr, said TPS elastomer being particularly chosen from the group consisting of SEBS copolymers, SEPS copolymers and blends of these copolymers.

In this application, the above self-sealing layer is combined with a gastight second layer in order to form a particularly effective airtight and puncture-resistant two-layer laminate. However, the gastight layer remains based on butyl rubber, and therefore relatively hysteretic.

Following their research, the Applicants have discovered that a single layer based on a specific thermoplastic elastomer, which does not require the presence of butyl rubber, unexpectedly makes it possible to effectively fulfil the above two roles of self-sealing on the one hand and of impermeability with respect to inflation gases on the other hand.

Thus, according to a first object, the present invention relates to an inflatable article equipped with a self-sealing elastomer layer impermeable to inflation gases, characterized in that said elastomer layer comprises at least, as major elastomer, a thermoplastic polystirene/polyisobutylene block copolymer and at least 100 phr of an extender oil.

The invention particularly relates to inflatable articles made of rubber such as pneumatic tires, or inner tubes, especially inner tubes for a pneumatic tire.

The invention relates more particularly to the pneumatic tires intended to be fitted on motor vehicles of the passenger type, SUV (Sport Utility Vehicle) type, two-wheeled vehicles (especially motorcycles), aircraft, industrial vehicles such as vans, heavy vehicles (that is to say underground trains, buses, road transport vehicles such as lorries, towing vehicles, trailers, off-road vehicles, such as agricultural and civil-engineering vehicles) and other transport or handling vehicles.

The invention also relates to the use as self-sealing layer impermeable to inflation gases, in an inflatable article, of a thermoplastic polystirene/polyisobutylene block copolymer and at least 100 phr of an extender oil.

The invention and its advantages will be easily understood in light of the description and of the exemplary embodiments that follow, and also from the single figure relating to these examples which schematically shows, in radial cross section, a pneumatic tire according to the invention.

### I. DETAILED DESCRIPTION OF THE INVENTION

In the present description, unless otherwise indicated, all the percentages (%) indicated are % by weight.

Moreover, any range of values denoted by the expression “between a and b” represent the field of values ranging from more than a to less than b (that is to say limits a and b excluded) whereas any range of values denoted by the expression “from a to b” means the field of values ranging from a up to b (that is say including the strict limits a and b).

### I-1. Self-Sealing, Gastight Elastomer Layer

The inflatable article according to the invention has the main feature of being equipped with a self-sealing layer impermeable to inflation gases that is formed from an elastomer composition (or “rubber”, the two terms being considered, as is known, to be synonymous) of the thermoplastic type, said layer or composition comprising at least, as major elastomer, a thermoplastic polystirene/polyisobutylene block copolymer and an extender oil at a weight content of at least 100 phr. These components are described in detail below.

### I-1-A. Polystirene/Polyisobutylene Block Copolymer

It will be recalled, first of all, that thermoplastic stirene (abbreviated to “TPS”) elastomers are thermoplastic elastomers which are in the form of stirene-based block copolymers. Having a structure intermediate between thermoplastic polymers and elastomers, they are composed, in a known manner, of hard polystirene blocks linked by flexible elastomer blocks, for example polybutadiene, polyisoprene or poly(ethylenelbutylene) blocks. They are often triblock elastomers with two hard segments linked by a flexible segment. The hard and flexible segments may be in a linear, star or branched configuration. These TPS elastomers may also be diblock elastomers with one single hard segment linked to a flexible segment. Typically, each of these segments or blocks contains at least more than 5, generally more than 10 base units (for example stirene units and isoprene units for a stirene/isoprene/stirene block copolymer).

It is recalled that the term “polystirene and polyisobutylene block copolymer” should be understood, in the present application, as meaning any thermoplastic stirene copolymer comprising at least one polystirene block (that is say one or more polystirene blocks) and at least one polyisobutylene block (that is to say one or more polyisobutylene blocks), with which other saturated or unsaturated blocks (for example polyethylene and/or polypropylene blocks) and/or other monomer units (for example unsaturated units such as diene units) may or may not be combined.

This specific polystirene and polyisobutylene block copolymer, also referred to as “TPS copolymer” in the present application, is in particular chosen from the group consisting of stirene/isobutylene (abbreviated to “SIB”) diblock copolymers, stirene/isobutylene/ stirene (abbreviated to “SIBS”) triblock copolymers and mixtures of these, by definition completely saturated, SIB and SIBS copolymers. The invention also applies to the case in which the polyisobutylene block, in the above copolymers, can be interrupted by one or more unsaturated units, in particular one or more diene units such as isoprene units, which are optionally halogenated.

It was observed that the use of this TPS, in particular SIB or SIBS, copolymer affords the self-sealing, gastight layer excellent impermeability properties while significantly reducing the hysteresis compared to conventional layers based on butyl rubber.

According to one preferred embodiment of the invention, the weight content of stirene in the TPS copolymer is between 5% and 50%. Below the minimum indicated, the thermoplastic nature of the elastomer runs the risk of being substantially reduced, whereas above the recommended maximum the elasticity of the airtight layer may be adversely affected. For these reasons, the stirene content is more preferably between 10% and 40%, in particular between 15 and 35%. The term “stirene” should be understood in the present description as meaning any monomer based on unsubstituted or substituted stirene; among substituted stirenes, mention may be made, for example, of methylstirenes (for example, α-methyl-stirene, β-methylstirene, p-methylstirene, tert-butylstirene), chlorostirenes (for example monochlorostirene, dichlorostirene).

It is preferable for the glass transition temperature (T_{g}, measured according to ASTM D3418) of the TPS copolymer to be below −20° C., in particular below −40° C. A T_{g} value above these minimum temperatures may reduce the performance of the self-sealing, gastight layer when used at a very low temperature; for such a use, the T_{g} of the TPS copolymer is more preferably still below −50° C.

The number-average molecular weight (denoted by Mₙ) of the TPS copolymer is preferably between 30,000 and 500,000 g/mol, more preferably between 40,000 and 400,000 g/mol. Below the minimum values indicated, the cohesion between the elastomer chains runs the risk of being adversely affected, especially due to the optional dilution thereof via an extender oil. Moreover, too high an Mₙ weight may be detrimental as regards the flexibility of the gastight layer. Thus, it has been observed that a value lying within a range of 50,000 to 300,000 g/mol was particularly suitable, especially for use of the composition in a pneumatic tire.

The number-average molecular weight (Mₙ) of the TPS copolymer is determined in a known manner by size exclusion chromatography (SEC). The specimen is first dissolved in tetrahydrofuran with a concentration of about 1 g/l; then the solution is filtered on a filter of 0.45 μm porosity before injection. The apparatus used is a WATERS Alliance chromatograph. The elution solvent is tetrahydrofuran, the flow rate is 0.7 ml/min, the temperature of the system is 35° C. and the analysis time is 90 min. A set of four WATERS columns in series having the trade names STYRAGEL (HMW7, HMW6E and two HT6E) is used. The injected volume of the polymer specimen solution is 100 The detector is a WATERS 2410 differential refractometer and its associated software for handling the chromatographic data is the WATERS MILLENNIUM system. The calculated average molecular weights are relative to a calibration curve obtained with polystirene standards.

The polydispersity index Iₚ (N.B: Iₚ=M_{w}/Mₙ where M_{w} is the weight-average molecular weight) of the TPS copolymer is preferably less than 3, more preferably Iₚ is less than 2.

The TPS copolymer and the extender oil associated therewith, in the recommended minimum content, may constitute by themselves the self-sealing, gastight elastomer layer or else they may be combined, in the elastomer composition, with other elastomers in a minor amount relative to the TPS copolymer.

If possible other elastomers are used in the composition, the TPS copolymer constitutes the major elastomer by weight. Its content is then preferably greater than 70 phr, especially in the range from 80 to 100 phr (as a reminder, “phr” means parts by weight per 100 parts of total elastomer or rubber, that is to say of all the elastomers present in the composition forming the gastight layer). Such additional elastomers, which are the minority by weight, could be for example diene elastomers such as natural rubber or a synthetic polyisoprene, a butyl rubber or thermoplastic elastomers other than stirene elastomers, within the limit of the compatibility of their microstructures.

Such additional elastomers, in minor amounts by weight, could also be other thermoplastic stirene elastomers that may be of the unsaturated type or the saturated type (i.e., as is known, these may or may not be provided with ethylenically unsaturated groups or carbon-carbon double bonds).

As examples of unsaturated TPS elastomers, mention may for example be made of those having stirene blocks and diene blocks, in particular those chosen from the group consisting of stirene/butadiene (SB), stirene/isoprene (SI), stirene/butadiene/butylene (SBB), stirene/butadiene/isoprene (SBI), stirene/butadiene/stirene (SBS), stirene/butadiene/butylene/stirene (SBBS), stirene/isoprene/stirene (SIS) and stirene/butadiene/isoprene/ stirene (SBIS) block copolymers and blends of these copolymers.

As examples of saturated TPS elastomers, mention may for example be made of those chosen from the group consisting of stirene/ethylene/butylene (SEB), stirene/ethylene/propylene (SEP), stirene/ethylene/ethylene/propylene (SEEP), stirene/ethylene/butylene/stirene (SEBS), stirene/ethylene/propylene/stirene (SEPS) and stirene/ethylene/ethylene/ propylene/stirene (SEEPS) block copolymers and blends of these copolymers.

However, according to one particularly preferred embodiment, the self-sealing, gastight layer contains no such additional elastomers. In other words, the TPS copolymer, in particular SIB or SIBS, described above, is the sole thermoplastic elastomer and more generally the sole elastomer present in the elastomer composition of the gastight layer.

Polystirene/polyisobutylene block copolymers are commercially available and may be processed in the conventional manner for TPS elastomers, by extrusion or moulding, for example starting from a raw material available in the form of beads or granules. For example, they are sold in respect of SIB or SIBS elastomers by KANEKA under the name “SIBSTAR” (e.g. “Sibstar 103T”, “Sibstar 102T”, “Sibstar 073T” or “Sibstar 072T” for the SIBSs; “Sibstar 042D” for the SIBs). They have for example been described, and also their synthesis, in patent documents EP 731 112, U.S. Pat. No. 4,946,899 and U.S. Pat. No. 5,260,383. They were firstly developed for biomedical applications then described in various applications specific to TPE elastomers, as varied as medical equipment, motor vehicle parts or parts for electrical goods, sheaths for electrical wires, sealing or elastic parts (see, for example, EP 1 431 343, EP 1 561 783, EP 1 566 405 and WO 2005/103146).

However, to the knowledge of the Applicants no prior art document describes the use in an inflatable article such as in particular a pneumatic tire, of an elastomer composition comprising in combination a polystirene/polyisobutylene block copolymer and at least 100 phr of an extender oil, which composition has proved, unexpectedly, not only able to fulfil a self-sealing layer role as described in the aforementioned application WO 2008/080557, but above all and also able to compete with conventional compositions based on butyl rubber as impermeable layer in inflatable articles.

### I-1-B. Extender Oil

The second essential constituent of the self-sealing, gastight layer is an extender oil (or plasticizing oil), used at a relatively high content, greater than or equal to 100 phr.

Any extender oil may be used, preferably one having a weakly polar character, capable of extending or plasticizing elastomers, especially thermoplastic elastomers. At ambient temperature (23° C.), these oils, which are relatively viscous, are liquids (i.e. as a reminder, substances having the capability of eventually taking the form of their container), as opposed especially to resins which are by nature solids.

Preferably, the extender oil is chosen from the group consisting of polyolefin oils (i.e. those resulting from the polymerization of olefins, monoolefins or diolefins), paraffinic oils, naphthenic oils (of low or high viscosity), aromatic oils, mineral oils and mixtures of these oils. More preferably, the extender oil is chosen from the group consisting of polybutene oils, paraffin oils and mixtures of these oils.

Very particularly, polybutene oils, polyisobutylene (PIB) oils, are used, which demonstrated the best compromise of properties compared with the other oils tested, especially compared with oils of paraffinic type.

Examples of polyisobutylene oils include those sold in particular by Univar under the trade name “Dynapak Poly” (e.g. “Dynapak Poly 190”), by BASF under the trade names “Glissopal” (e.g. “Glissopal 1000”) or “Oppanol” (e.g. “Oppanol B12”), by Ineos Oligomer under the trade name “Indopol H1200”. Paraffinic oils are sold for example by Exxon under the trade name “Telura 618” or by Repsol under the trade name “Extensol 51”.

The number-average molecular weight (Mₙ) of the extender oil is preferably between 200 and 25,000 g/mol, more preferably still between 300 and 10,000 g/mol. For excessively low Mₙ values, there is a risk of the oil migrating to the outside of the composition, whereas excessively high Mₙ values may result in this composition becoming too stiff, which would be detrimental to the self-sealing properties. An Mₙ value between 350 and 4000 g/mol, in particular between 400 and 3000 g/mol, proves to be an excellent compromise for the intended applications, in particular for use in a pneumatic tire.

The molecular weight Mₙ of the extender oil is determined by SEC, the specimen being firstly dissolved in tetrahydrofuran with a concentration of about 1 g/l and then the solution is filtered on a filter of 0.45 μm porosity before injection. The apparatus is the WATERS Alliance chromatograph. The elution solvent is tetrahydrofuran, the flow rate is 1 ml/min, the temperature of the system is 35° C. and the analysis time is 30 min. A set of two WATERS columns with the trade name “STYRAGEL HT6E” is used. The injected volume of the polymer specimen solution is 100 μl. The detector is a WATERS 2410 differential refractometer and its associated software for handling the chromatograph data is the WATERS MILLENIUM system. The calculated average molecular weights are relative to a calibration curve obtained with polystirene standards.

A person skilled in the art will know, in the light of the description and the embodiments that follow, how to adjust the quantity of extender oil according to the particular usage conditions of the self-sealing layer impermeable to inflation gases, in particular of the inflatable article in which it is intended to be used.

One major and noteworthy advantage of the present invention is that the adjustment, in the formulation, of the extender oil content, typically within a range from 100 to 700 phr, will advantageously make it possible, depending on the particular usage conditions that are targeted, to favour the impermeability properties for the most part (with a lower content of extender oil) or the self-sealing properties for the most part (with a higher content of extender oil).

From this viewpoint, for an optimal compromise of properties, it is preferred that the content of extender oil, in particular of polybutene oil, is at least equal to 120 phr, in particular between 120 and 700 phr; more preferably, this extender oil content is at least equal to 150 phr, in particular within a range from 150 to 500 phr. Below the indicated minima, the elastomer layer runs the risk of having too high a stiffness for certain applications, whereas above the recommended maximum there is a risk of the composition having insufficient cohesion and of a loss of impermeability which may be detrimental depending on the application in question.

The self-sealing, gastight layer or composition described previously is a compound that is solid (at 23° C.) and elastic, which is especially characterized, owing to its specific formulation, by a very high flexibility and very high deformability.

According to one preferred embodiment of the invention, this elastomer layer or composition has a secant modulus in extension, at 10% elongation, which is less than 2 MPa, more preferably less than 1.5 MPa (especially less than 1 MPa). This quantity is measured at first elongation (that is to say without an accommodation cycle) at a temperature of 23° C., with a pull rate of 500 mm/min (ASTM D412 standard), and normalized to the initial cross section of the test specimen.

### I-1-C. Various Additives

The two constituents described previously, namely TPS copolymer and extender oil, are sufficient by themselves for the self-sealing, gastight composition to completely fulfil its impermeability and puncture-resistance functions with respect to the inflatable articles in which it is used.

However, various other additives may be added, such as, for example, reinforcing fillers such as carbon black or silica, non-reinforcing or inert fillers, platy fillers further improving the impermeability (e.g. phyllosilicates such as kaolin, talc, mica, graphite, clays or modified clays (“organoclays”), plasticizers other than the aforementioned extender oils, for example, tackifying resins, protective agents such as antioxidants or antiozonants, UV stabilizers, colorants that can advantageously be used for colouring the composition, various processing aids or other stabilizers, or else promoters capable of promoting adhesion to the remainder of the structure of the inflatable article.

The use of platy fillers advantageously makes it possible to further reduce the permeability coefficient (and therefore to increase the impermeability) of the thermoplastic elastomer composition, without excessively increasing its modulus. This makes it possible to maintain the integratability of the airtight layer in the inflatable article. Such fillers generally take the form of plates, platelets, sheets or stacked sheets, of relatively pronounced anisotropy, the mean length of which is for example between a few μm and a few hundred μm. They may be used in variable weight contents depending on the applications, for example between 20 and 150 phr.

Besides the elastomers described previously, this airtight composition could also comprise, always in a minority weight fraction relative to the TPS copolymer, polymers other than elastomers, such as for example thermoplastic polymers compatible with the TPS elastomers.

### I-2. Use of the Self-Sealing, Airtight Layer in an Inflatable Article

The composition described previously can be used as a self-sealing, airtight layer in any type of inflatable article. As examples of such inflatable articles, mention may be made of inflatable boats, balloons or balls used for games or sports.

It is particularly suitable for use in an inflatable article, whether a finished or semi-finished product, made of rubber, most particularly in a pneumatic tire for a motor vehicle such as a two-wheeled, passenger or industrial vehicle.

Such a self-sealing layer impermeable to inflation gases is preferably placed on the inner wall of the inflatable article, but it may also be completely integrated into its internal structure.

The thickness of this layer is preferably greater than 0.2 mm, more preferably between 0.3 mm and 30 mm, especially between 0.5 and 20 mm.

It will be readily understood that, depending on the specific fields of application and on the dimensions and pressures involved, the method of implementing the invention may vary, the self-sealing, gastight layer then having several preferential thickness ranges. Thus, for example, in the case of passenger or two-wheeled vehicle tires, it may have a thickness of at least 0.5 mm, preferably between 1 and 4 mm. According to another example, in the case of heavy or agricultural vehicle tires, the preferred thickness may be between 2 and 20 mm. According to another example, in the case of pneumatic tires for vehicles in the civil engineering field or for aircraft, the preferred thickness may be between 4 and 30 mm.

Compared with a usual layer based on butyl rubber, the self-sealing, airtight composition described above has the advantage of exhibiting a markedly lower hysteresis, and therefore of offering the pneumatic tires a reduced rolling resistance, as is demonstrated in the following exemplary embodiments.

### II. Exemplary Embodiments of the Invention

The self-sealing elastomer layer impermeable to inflation gases described previously can advantageously be used in the pneumatic tires of all types of vehicles, in particular passenger vehicles or industrial vehicles such as heavy vehicles.

As an example, the single appended figure shows very schematically (not drawn to scale), a radial cross section of a pneumatic tire according to the invention, intended for example for a passenger vehicle.

This pneumatic tire 1 has a crown 2 reinforced by a crown reinforcement or belt 6, two sidewalls 3 and two beads 4, each of these beads 4 being reinforced with a bead wire 5. The crown 2 is surmounted by a tread (not shown in this schematic figure). A carcass reinforcement 7 is wound around the two bead wires 5 in each bead 4, the upturn 8 of this reinforcement 7 lying for example towards the outside of the pneumatic tire 1, which here is shown fitted onto its rim 9. The carcass reinforcement 7 consists, as is known per se, of at least one ply reinforced by cords, called “radial” cords, for example textile or metal cords, i.e. these cords are arranged practically parallel to one another and extend from one bead to the other so as to form an angle of between 80° and 90° with the circumferential mid-plane (the plane perpendicular to the rotation axis of the pneumatic tire, which is located at mid-distance of the two beads 4 and passes through the middle of the crown reinforcement 6).

The inner wall of the pneumatic tire 1 comprises a self-sealing, airtight layer 10, for example having a thickness equal to around 4 mm, on the side of the internal cavity 11 of the pneumatic tire 1. This inner layer (or “inner liner”) covers the entire inner wall of the pneumatic tire, extending from one sidewall to the other, at least as far as the rim flange when the pneumatic tire is in the fitted position.

According to this particular example, the layer 10 above is a layer of SIBS thermoplastic elastomer (“Sibstar 102T” with a stirene content of around 15%, a T_{g} of around −65° C. and a weight Mₙ of around 90,000 g/mol), extended with 150 phr of PIB oil (“Indopol H1200” with a weight Mₙ of around 2100 g/mol).

The first role of the layer 10 is to provide effective protection against pressure losses due to accidental perforations, by enabling these perforations to be automatically sealed. If a foreign body such as a nail passes through the structure of the inflatable article, for example a wall such as a sidewall 3 or the crown 6 of the pneumatic tire 1, the composition serving as self-sealing layer is subjected to several stresses. In reaction to these stresses, and owing to its advantageous deformability and elasticity properties, said composition creates a sealed contact region around the entire body. It matters little whether the outline or profile of said body is uniform or regular, the flexibility of the self-sealing composition enabling it to penetrate into minute openings. This interaction between the self-sealing composition and the foreign body seals up the region affected by the latter.

In the event of the foreign body being removed, whether accidentally or intentionally, a perforation remains, which can generate a relatively substantial leak, depending on its size. The self-sealing composition, exposed to the hydrostatic pressure, is sufficiently flexible and deformable to close up, by deforming, the perforation, preventing the inflation gas from leaking out. Especially in the case of a pneumatic tire, it has turned out that the flexibility of the self-sealing composition can withstand without any problem the forces from the surrounding walls, even during deformation phases of the loaded pneumatic tire and when the latter is running.

The second role of this same layer 10 is to ensure the impermeability and to protect the carcass reinforcement from the diffusion of air coming from the internal space 11 of the pneumatic tire. It enables the pneumatic tire to be inflated and kept under pressure. Its impermeability properties ought to enable it to guarantee a relatively low rate of pressure loss, and to make it possible to keep the pneumatic tire inflated, in the normal operating state, for a sufficient time, normally several weeks or several months.

The pneumatic tire provided with its self-sealing, airtight elastomer layer (10) as described above may be produced before or after vulcanization (or curing).

In the first case (i.e., before curing of the pneumatic tire), this elastomer layer is simply applied in a conventional manner at the desired place, so as to form the layer 10. The vulcanization is then carried out conventionally. One advantageous manufacturing variant, for a person skilled in the art of pneumatic tires, would consist for example during a first step, in laying down the elastomer layer directly onto a building drum, in the form of a layer with a suitable thickness, before this is covered with the rest of the structure of the pneumatic tire, according to manufacturing techniques well known to a person skilled in the art.

In the second case (i.e. after curing of the pneumatic tire), the elastomer layer is applied to the inside of the pneumatic tire cured by any appropriate means, for example by bonding, by extrusion, by spraying or else by extrusion/blow moulding a film of suitable thickness.

Pneumatic tires according to the invention, of the passenger vehicle type (dimensions 195/65 Rb), were manufactured; their inner wall was covered with a self-sealing, gastight layer (10) having a thickness of 4 mm (laid on a building drum, before manufacture of the rest of the tire), then the tires were vulcanized. Said layer (10) was formed from SIBS extended with 150 phr of PIB oil, as described above.

During tests, these pneumatic tires provided with the layer (10) above were firstly tested as described in the aforementioned application WO 2008/080557, in order to evaluate the self-sealing properties of the layer (10). After having perforated the tread and the crown block using punches with a diameter of 6 mm, then having removed these punches, it was observed that the pneumatic tires of the invention gave performances substantially equivalent to those known from the application WO 2008/080557, namely that these tires thus perforated nevertheless withstood sustained running at high speed (130 km/h) without loss of pressure for several thousands of kilometres.

The impermeability properties were then analysed on test specimens of compositions based on butyl rubber on the one hand (thickness: 1 mm), and on SIBS and extender oil (150 phr) on the other hand for the self-sealing, airtight layer (thickness: 4 mm); of course, the self-sealing role of the latter layer requires the use of thicknesses substantially greater than those of standard impermeable layers.

For this analysis, a rigid-wall permeameter was used, placed in an oven (temperature of 60° C. in the present case), equipped with a pressure sensor (calibrated in the range of 0 to 6 bar) and connected to a tube equipped with an inflation valve. The permeameter may receive standard test specimens in disc form (for example having a diameter of 65 mm in the present case) and with a uniform thickness which may range up to 3 mm (0.5 mm in the present case). The pressure sensor is connected to a National Instruments data acquisition card (0-10 V analogue four-channel acquisition) which is connected to a computer that carries out a continuous acquisition with a frequency of 0.5 Hz (1 point every two seconds). The permeability coefficient (K) is measured from the linear regression line (average over 1000 points) giving the slope a of the pressure loss, through the test specimen tested, as a function of the time, after a stabilization of the system, that is to say after obtaining a steady state during which the pressure decreases linearly as a function of the time.

It was firstly observed that the SIBS layer thus extended ultimately had an impermeability identical to that of the conventional butyl layer, the degradation caused by the extender oil in fact being completely compensated for by the increase in the thickness of the SIBS layer, furthermore essential to the self-sealing role.

It was also noted that the permeability coefficient of the SIBS layer was significantly less degraded (increased by around 50% instead of 125%) in the presence of a PIB oil (“Dynapak Poly 190”) than a conventional oil such as a paraffinic oil (“Telura 618”). This is why the combination of the TPS copolymer such as SIB or SIBS and of PIB oil has proved to offer the best compromise of properties in respect of the self-sealing, gastight layer. Finally, the pneumatic tires of the invention were compared with control tires (Michelin “Energy 3” brand) comprising a conventional airtight layer, of the same thickness, based on butyl rubber. The rolling resistance of the pneumatic tires was measured on a flywheel, according to the ISO 8767 (1992) method.

It was observed that the pneumatic tires of the invention had a rolling resistance that was reduced very significantly, and unexpectedly for a person skilled in the art, by almost 4% relative to the control pneumatic tires.

In conclusion, an elastomer composition comprising, in combination, a polystirene/polyisobutylene block copolymer and at least 100 phr of extender oil has proved, unexpectedly, not only able to fulfil the role of a self-sealing layer as described in particular in the aforementioned application WO 2008/080557, but also and above all able to replace a conventional composition based on butyl rubber as impermeable layer in pneumatic tires, with in addition the opportunity of substantially reducing the hysteresis of these tires, and therefore the fuel consumption of motor vehicles fitted with such tires.

1. An inflatable article equipped with a self-sealing elastomer layer impermeable to inflation gases, wherein said elastomer layer comprises at least, as major elastomer, a thermoplastic polystirene/polyisobutylene block copolymer and at least 100 phr of an extender oil.

2. The inflatable article according to claim 1, wherein the thermoplastic copolymer is chosen from the group consisting of stirene/isobutylene copolymers, stirene/isobutylene/stirene copolymers and mixtures of these copolymers.

3. The inflatable article according to claim 2, wherein the thermoplastic copolymer is a stirene/isobutylene/stirene copolymer.

4. The inflatable article according to claim 1, wherein the thermoplastic copolymer comprises between 5 and 50% by weight of stirene.

5. The inflatable article according to claim 1, wherein the glass transition temperature of the thermoplastic copolymer is less than −20° C.

6. The inflatable article according to claim 1, wherein the number-average molecular weight of the thermoplastic copolymer is between 30,000 and 500,000 g/mol.

7. The inflatable article according to claim 1, wherein the extender oil is chosen from the group consisting of polyolefin oils, paraffinic oils, naphthenic oils, aromatic oils, mineral oils, and mixtures of these oils.

8. The inflatable article according to claim 7, wherein the extender oil is chosen from the group consisting of polybutene oils.

9. The inflatable article according to claim 8, in wherein the extender oil is a polyisobutylene oil.

10. The inflatable article according to claim 1, wherein the number-average molecular weight of the extender oil is between 200 and 25,000 g/mol.

11. The inflatable article according to claim 1, wherein the content of extender oil is at least equal to 120 phr.

12. The inflatable article according to claim 11, wherein the content of extender oil is at least equal to 150 phr.

13. The inflatable article according to claim 1, wherein the elastomer layer has a thickness greater than 0.2 mm.

14. The inflatable article according to claim 13, wherein in which the elastomer layer has a thickness between 0.3 and 30 mm.

15. The inflatable article according to claim 1, wherein the elastomer layer is placed on the inner wall of the inflatable article.

16. The inflatable article according to claim 1, wherein said article is made of rubber.

17. The inflatable article according to claim 16, wherein said rubber article is a pneumatic tire.

18. The inflatable article according to claim 16, wherein said inflatable article is an inner tube.

19. (canceled)
